(19) United States
(12) Patent Application Publication
(10) Pub. No.: US 2019/0079026 A1
(43) Pub. Date: Mar. 14, 2019

(54) SINGLE SCATTERER TEST USING PHASE

(71) Applicant: Delphi Technologies, LLC, Troy, MI (US)

(72) Inventors: Konstantin Statnikov, Dusseldorf (DE); Alexander Ioffe, Bonn (DE)

(21) Appl. No.: 16/106,474

(22) Filed: Aug. 21, 2018

(30) Foreign Application Priority Data
Sep. 12, 2017 (EP) 17190579.7

(51) Int. Cl. G01N 22/00

(52) U.S. Cl. CPC G01N 22/00; G01N 2223/052

(57) ABSTRACT

A vehicle based method of determining the extent to which a target object is a single scatterer, said vehicle including a radar system including a radar transmit element, adapted to send a radar signal towards said target object, and an antenna receive element adapted to receive radars signals reflected from said target object, said method comprising: a) transmitting a radar signal from said radar transmit element to said target object; b) receiving the reflected signal of the signal transmitted in step a) from the target object at said receiver element; c) processing the received signal to provide phase data in the frequency domain; d) determining a measure of the phase change between frequencies; e) determining whether the target object is a single scatterer based on the results of step d).

### TECHNICAL FIELD OF INVENTION

This invention relates to a method of detection and subsequent characterization of objects using radar techniques and in particular determining whether an object is a single scatterer. It has application in determining a suitable landmark for geographical mapping for the purpose of determining the position of a host vehicle.

### BACKGROUND OF INVENTION

Self-localization, that is determining the precise location of a host vehicle is one of the most important functions for accurate automated driving or such driver assistance schemes such as collision prevention systems. Current car navigation systems generally use a GPS navigation system to estimate the vehicle position. However, such a GPS navigation system is insufficient for precise self-localization of road vehicles due to effects such as reflections caused by buildings and occlusions of GPS signals from satellites. To overcome this problem, many landmark-based ego localization approaches have been elaborated in the past.

It is known to equip vehicles with radar systems/modules. Such radar systems are able to detect radar reflections (i.e. radar detections) from objects in the vicinity and process the data with respect to said radar reflections. Usually, the information needed for current self-localization and mapping (SLAM) procedure is collected from such (reflection/detection) data provided by the radar modules over multiple consecutive scans to identify for example a fixed landmark. This mapping information is updated over time, and a precise superposition of the individual radar-based maps with the GPS maps is performed. In such a way, for example the geographical position determined by GPS is accurately refined by such local data from radar returns.

Thus, in order to reduce the accumulation of errors introduced by non-precise superposition, landmark-based alignment of those radar images is a preferred solution. In the landmark-based SLAM procedure, a key task is to determine one or more suitable landmarks (i.e. objects) in the environment, i.e. in the vicinity of the vehicle which could serve as suitable and quality positional references (anchors) for precise superposition of the individual maps.

Available landmark determination approaches are based on e.g. signal-to-clutter ratio, point spread function matching, image analysis (e.g. by gradient analysis, or template matching etc.), likelihood ratio test, range bin variance analysis or differential interferogram methodologies. However, those approaches are not intended for the automotive environment. Landmarks have been previously examined by single-scan observations from a certain view-angle. Those approaches are typically not robust enough due to complexity of the automotive environment.

Determining whether an object is a single-scatterer can be helpful in determining whether a landmark is suitable so an aim is to determine the extent to which a scatterer under test (SUT) is a single scatterer (originates from a single scattering center). For example, pulse-Doppler radar signal processing can be used to separate reflected signals into a number of “peaks”, which occur in the 2-D spectral domain (called range-Doppler map). This spectral data collected from multiple radar receiver channels is utilized to carry out the here proposed single scatterer test.

Several state-of-the-art techniques are known which can be used to determine whether a target response originates from a single scatterer or not (e.g. the co-pending application EP 16188715). One method to analyze if a target response originates from a single scatterer is to involve a (complex-valued) cross-correlation between the measured radar response with the corresponding so called system-dependent Point Spread Function (PSF). PSF of a radar system describes namely its response to an ideal single-scatterer target. If the correlation coefficient is below a (e.g. predetermined) threshold, then the target is considered to be a non-single scatterer.

The cross-correlation involves computational complexity. Additionally, this method is not very sensitive. The current application relates to an improved method of determining whether a target object identified is a single scatterer.

### SUMMARY OF THE INVENTION

It is an object of the invention to overcome these problems. One object is to provide a method to determine the suitability of a landmark as a reference. The aim of the proposed method is to determine the extent to which a scatterer under test (SUT) is a single scatterer (originates from a single scattering center).

In one aspect is provided a vehicle based method of determining the extent to which a target object is a single scatterer, said vehicle including a radar system including a radar transmit element, adapted to send a radar signal towards said target object, and an antenna receive element adapted to receive radars signals reflected from said target object, said method comprising:
a) transmitting a radar signal from said radar transmit element to said target object;
b) receiving the reflected signal of the signal transmitted in step a) from the target object at said receiver element;
c) processing the received signal to provide phase data in the frequency domain in relation to discrete bins comprising frequency ranges;
d) determining a the phase change between at least two bins;
e) determining whether the target object is a single scatterer based on the results of step d), wherein the target object is considered to be a non-single scatterer if the phase change from one frequency bin to a neighboring frequency bin is above a threshold.

In step c) signal data may be converted from the base time-domain to a range-Doppler frequency domain.

Step c) may include providing a range-Doppler map in terms of range-Doppler frequency domain.

Step c) may include providing phase data in term of range-Doppler frequency bins.

Step d) may comprise determining bin-to-bin phase change.

In step e) if the phase change between two frequencies or frequency bins is above a threshold, the target object is considered to be a non-single scatterer.

Steps d) and e) may only performed for the bins from a main-lobe 1-D or 2-D region of the received radar point spread function.

In step c) only phase information from the 2-D measured data in a range-Doppler domain is extracted for frequencies or bins where the amplitude or power exceeds a threshold or which have a minimum signal-to-noise ratio.

Step d) may comprise measuring bin-to-bin phase change across the measured 2-D point spread function evaluated in a range-Doppler domain.

### BRIEF DESCRIPTION OF DRAWINGS

The present invention is now described by way of example with reference to the accompanying drawings in which:

FIG. 1 shows a flowchart of basic methodology according to one example;

FIG. 2 shows a schematic showing two PSFs corresponding to two scattering centers located in a close proximity to each other in space/in spectrum;

FIG. 3 shows the results of phase determined against frequency bin for a spectral response of a non-single-scatterer target (comprised as a superposition of two individual targets/responses).

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

‘One or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The aim of the proposed method is to determine the extent to which a scatterer under test (SUT) is a single scatterer (originates from a single scattering center). For example, pulse-Doppler radar signal processing can be used to separate reflected signals into a number of “peaks”, which occur in the 2-D spectral domain (called range-Doppler map). This spectral data is utilized to carry out the here proposed single scatterer test.

The problem of determination if a radar backscatter return originates from a single scattering center is solved using an efficient method of a 2-D phase evaluation in the range-Doppler domain.

The 2-D frequency-domain data (the range-Doppler map) is analyzed. Typically the data is arranged in terms of a set of frequency ranges or “bins”. As it is a matter of interference between signals reflected from scattering centers located in relative close proximity to each other (in terms of range/Doppler frequencies), relative phase difference between signals can be directly evaluated in the frequency domain local to the superposed signal frequency bin.

In the proposed method, phase information from the (2-D) measured complex data (in the range-Doppler domain) is extracted at the position of the peak (considering only those bins where the amplitude exceeds some threshold or having a minimum SNR, respectively). Then, the bin-to-bin phase change across the (whole) measured 2-D PSF (corresponding to a detected target) is evaluated in the range-Doppler domain. The amount of the neighboring bins is not limited. Even having only two neighboring bins (offering the needed SNR), the test can be executed.

The method is preferably executed on the bins from the main-lobe 2-D region of the PSF (also called “peak”).

In a preferred example, the method may be reduced (for a better runtime performance) to the phase analysis of only the vectors in the two orthogonal dimensions (range and Doppler) going through the estimated amplitude peak position (as a function of range/Doppler frequency). This provides a sub-set of bins compared to the analysis of all bins of a 2-D PSF.

In the specifics of the methodology, if the absolute bin-to-bin phase change (slope) exceeds some known threshold (which may be different for the different bins of a PSF), then the target is considered to be a non-single scatterer.

For example, the phase of all bins belonging to the main lobe of an ideal single scatterer PSF would be namely equal/“flat” when the windowing function is symmetrical, the number of samples (processed by e.g. a Fourier transform) is odd, and (if zero padding is needed) the so-called zero-phase zero padding approach is applied.

This methodology is applicable to a system which includes a single receiver channel (receiver element), but also on M range-Doppler responses (maps) from N receiver (RX) channels.

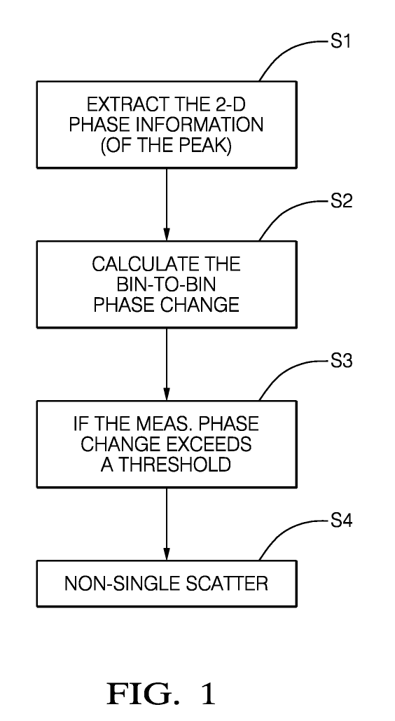

FIG. 1 shows a flow chart of the general methodology according to one aspect.

A (vehicle-based) radar system comprising an antenna transmit element and a receive element (or array) having at least one receive element sends out a radar signal and so the received reflected signal from a target object is received by the receiver element(s) and processed. The subsequent processing of the received radar signal, i.e. analysis is described with reference to flowchart of FIG. 1.

In the proposed method, 2-D frequency-domain data (a range-Doppler map) is analyzed. In step S1 the phase of the signal is extracted from the 2-D frequency domain data at the position of the amplitude peak. Typically, the data is arranged in terms of a set of frequency ranges—so called Doppler “bins”. As it is a matter of interference between signals reflected from scattering centers located in relative close proximity to each other in space (and/or having similar Doppler frequency), amplitude spectral information from the (2-D) measured complex data (in the range-Doppler domain) are evaluated at the position of the resulting “peak” to determine if the measured response originates from a single scattering center or not.

In step S2 the frequency (bin) to frequency (bin) phase is determined.

In step S3 the phase change from one frequency (bin) to a neighboring one frequency (bin) is compared with a threshold. If this phase difference (after phase unwrapping) exceeds the threshold in step S4, the target is identified as a non-single scatterer.

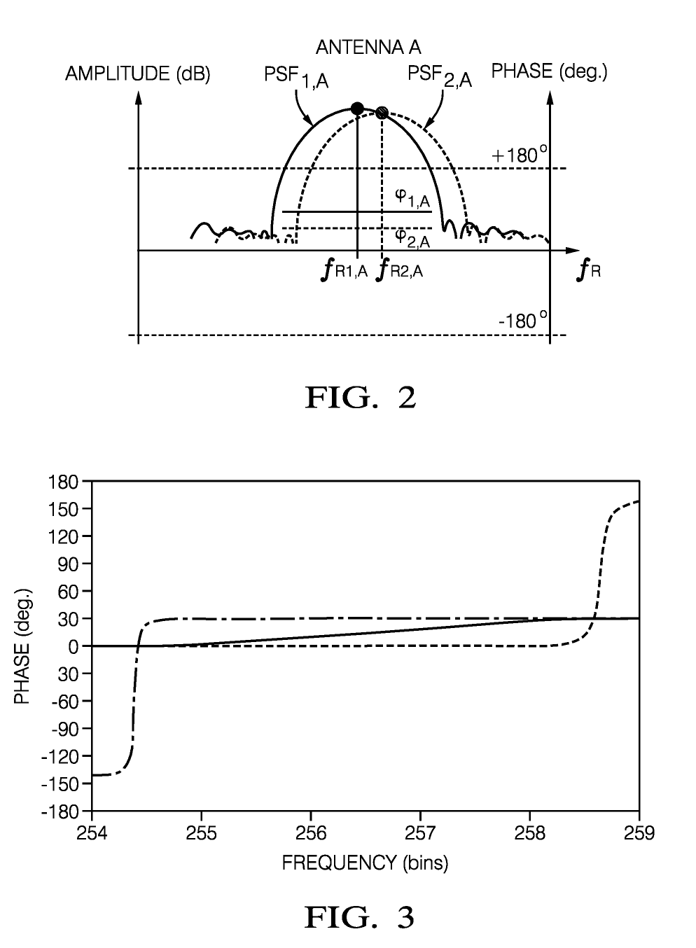

Consider a situation where two scattering centers (referred to as Target 1 and 2) are located in a close proximity to each other in space (having the same Doppler frequency). Then, at the receiver antenna, a superposition of those two scattered signals occurs. In the range-Doppler map, the PSFs from two targets e.g. of a non-single scatterer (named PSF1 and PSF2) referenced as PSF 1,A and PSF 2,A may be close to each other and would overlap—see FIG. 2. Thus, the amplitudes and the phases of the complex-valued PSFs have a strong influence on the resulting PSF due to complex superposition of the individual PSFs (see FIG. 2). The peak amplitude is shown at frequency fR1,A and fR2,A respectively for the PSF1,A and PSF 2,A.

Exemplarily, a 1-D case was simulated where two PSFs with a frequency distance of 1.0 frequency bin were put in a close proximity to each other. The first PSF (PSF1) has amplitude of 1.0 and phase of 0 degrees, and the second one (PSF2) has amplitude of 0.9 and phase of 30 degrees.

FIG. 3 shows the results of phase determined against frequency bin for the first PSF only (reference numeral 1) the second PSF only (reference numeral 2) and for the actual superposed signal (which is the signal that would be received in reality): reference numeral 3.

So FIG. 3, shows the simulated phase spectrum (e.g. phase vs. frequency bins shown as a 1-D cut through a 2-D frequency map). As one can see, the phase of the superposed resulting peak is not flat. Thus, the peak under tests is determined to originate from a non-single scatterer.

In contrast to the method disclosed on European Patent Application

EP 16188715, no symmetry needs to be considered. Thus, the here proposed method could be executed even having only two neighboring bins (offering the needed SNR), instead of three, which would be needed in EP 16188715.

The method is very sensitive, can be executed on a single range-Doppler map (originating from a single RX channel), and has a low computational cost.

1. A vehicle based method of determining the extent to which a target object is a single scatterer, said vehicle including a radar system including a radar transmit element, adapted to send a radar signal towards said target object, and an antenna receive element adapted to receive radars signals reflected from said target object, said method comprising:
a) transmitting a radar signal from said radar transmit element to said target object;
b) receiving the reflected signal of the signal transmitted in step a) from the target object at said receiver element;
c) processing the received signal to provide phase data in the frequency domain in relation to discrete bins comprising frequency ranges;
d) determining a phase difference between at least two bins;
e) determining whether the target object is a single scatterer based on the results of step d), wherein the target object is considered to be a non-single scatterer if the phase change from one frequency bin to a neighboring frequency bin is above a threshold.

2. A method as claimed in claim 1, wherein in step c) signal data is converted from the base time-domain to a range-Doppler frequency domain.

3. A method as claimed in claim 1, wherein step c) includes providing a range-Doppler map in terms of range-Doppler frequency domain.

4. A method as claimed in claim 1, wherein step c) includes providing phase data in term of range-Doppler frequency bins.

5. A method as claimed in claim 1, wherein step d) comprises determining bin-to-bin phase change.

6. A method as claimed in claim 1, wherein if the absolute bin-to-bin phase change or the slope of the phase change to respective frequency exceeds a threshold, the target is considered to be a non-single scatterer.

7. A method as claimed in claim 1, wherein steps d) and e) are only performed for the bins from a main-lobe region of the received radar point spread function.

8. A method as claimed in claim 1, wherein in step c) only phase information from the 2-D measured data in a range-Doppler domain is extracted for frequencies or bins where the amplitude or power exceeds a threshold or which have a minimum signal-to-noise ratio.

9. A method as claimed in claim 1, wherein step d) comprises measuring bin-to-bin phase change across the measured 2-D point spread function evaluated in a range-Doppler domain.
